(19) United States
(12) Patent Application Publication
(10) Pub. No.: US 2022/0390390 A1
(43) Pub. Date: Dec. 8, 2022

(54) MATERIAL ANALYSIS AND SEPARATION SYSTEM FOR THE DETERMINATION OF THEIR CHEMICAL COMPOSITION AND MATERIAL ANALYSIS AND SEPARATION METHOD FOR THE DETERMINATION OF THEIR CHEMICAL COMPOSITION

(71) Applicant: : COMEX POLSKA Sp. z.o.o., Krakow (PL)

(72) Inventor: Jacek KOLACZ, Krakow (PL)

(73) Assignee: COMEX POLSKA Sp. z.o.o., Krakow (PL)

(21) Appl. No.: 17/772,087

(22) PCT Filed: Aug. 14, 2020
(86) PCT No.: PCT/PL2020/000068

§ 371 Date: Apr. 26, 2022

(51) Int. Cl. G01N 23/083; G01N 21/3563

(52) U.S. Cl. CPC G01N 23/083; G01N 21/3563

(57) ABSTRACT

A material analysis and separation system equipped with a conveyor belt, X-ray source, X-ray detector, which has the X-ray source located in such a way that X rays penetrate the measured material over the entire width of the conveyor belt, and the radiation detectors consist of multiple radiation sensors located on the entire width of the belt, while the sensor system is equipped with devices that allow for data processing in dual energy (DE Dual Energy) or multi-energy (ME Multi Energy) X-ray analysis range. The system also includes a computer unit that controls the system rejecting material particles falling below the separation criterion threshold and devices receiving separated material fractions. The X-ray analysis system is equipped with a hyper-spectral analysis system in the range of infra-red radiation using a source of infra-red radiation (15) and hyper-spectral camera (19).

The subject of the invention is material analysis and separation system for the determination of their chemical composition and material analysis and separation method for the determination of their chemical composition, type, class and form of occurrence. Such separation can be used to sort materials such as rocks, minerals, metal ores, metals, objects in the recycling process, general waste and other materials where it is important to determine their chemical composition for further separation.

The design of a material separation device is known from US Patent US2006171504A1 or US2007086568A1. In that method, radiation detectors have a double layer of sensors analysing the same piece of material. After passing through the analysed material, X-rays fall on the first layer of sensors. The first layer directly analyses the amount of X-ray energy falling on the sensor after passing through the sample material. The second layer is located behind the X-ray inhibiting filter and also measures the radiation energy. In this way, the first layer measures the total energy (E_{T}) of the X-ray photons that reach the sensor, both those with high (E_{H}) and low (E_{L}) energy. The second layer of sensors only measures E_{H} photons, because those with lower energy have been absorbed by the filter. In this way it is possible to measure two levels of energy passing through the analysed material. The top layer of the sensors measures E_{T}, and the bottom layer only measures E_{H}. By subtracting these signals from each other, we obtain E_{L}=E_{T}−E_{H}. In some detectors, it is possible to separate the E_{L} and the E_{H} by the specific detector construction. In such a case, the first top layer of sensors only absorbs and measures the low energy photons (E_{L}) and the high energy photons are passing through without being measured. These high energy photons (E_{H}) are measured by the second layer of sensors places after the filter. However, there is always a part of high energy photons, incidentally measured by the first top layer of sensors, thus providing a defused measurement depending on detector characteristics and consequently inaccurate sensor reading. At the same time, it is well known that when X-rays penetrate matter, the radiation energy is suppressed. The degree of energy attenuation depends mainly on the phenomena that arise in this system: photoelectric phenomenon, Compton scattering and the formation of electron-positron pairs. During the penetration of X rays with energy of up to about 200 keV, in most materials only the first two phenomena occur: photoelectric and Compton scattering, and these phenomena depend on the amount of X-ray energy reaching the material and the type of material. For example, 1 mm thick aluminium subjected to X-radiation with the energy of 100 keV has the attenuation factor of 4.48%, and with the energy of 50 keV, it is 9.45%. At the same time, the same thickness of copper has the attenuation factor of 33.6% at 100 keV, and 90.3% at 50 keV. Comparing the quotients of these coefficients at E₅₀/E₁₀₀ we get 2.1 for aluminium and 2.7 for copper. The main limitation of the two-energy method is that each sensor measuring the energy of photons falling in on a given sensor, for both the first and the second layer, measures the sum of a specific group of X-ray photons. They are scintillator-based sensors. X-ray photons fall on the outer layer of the sensor, where the scintillator is located. It is usually a crystal of the material being excited by X-radiation that causes the effect of illumination with visible light, which is measured by a photodiode. When the X-ray photon gets into the scintillator crystal, there is a photoelectric effect and Compton scattering, similarly to the previously analysed material. However, in the case of a scintillator, the photoelectric effect can be effectively converted into visible light photons and their intensity can be measured. The intensity is proportional to the energy and quantity of X-rays photons falling on the scintillator crystal. However, as a result, when low and high energy X-ray photons reach the sensor at almost the same time, the measured energy of these photons will be summed up, i.e. it will be the measurement of the total energy that has reached the scintillator sensor. These restrictions mean that it is not possible to distinguish many types of materials. This fact becomes especially important in the case of separation of mixed materials (such as minerals or metal alloys), where the material includes many elements and their compounds. In such case the two-energy measurement is imprecise, and the interpretation of the material type based only on two energy levels is difficult and chaotic.

The purpose of the invention is the development of material analysis and separation system for the determination of their chemical composition and material analysis and separation method for the determination of their chemical composition, type, class and form of occurrence.

Material analysis and separation system equipped with a conveyor belt, X-ray source, X-ray detector, which has the X-ray source located in such a way that X rays penetrate the measured material over the entire width of the conveyor belt, and the radiation detectors consist of multiple radiation sensors located on the entire width of the belt, while the sensor system is equipped with devices that allow for data processing in dual energy (DE Dual Energy) or multi-energy (ME Multi Energy) X-ray analysis range. The system also includes a computer that controls the system rejecting material particles falling below the separation criterion threshold and devices receiving separated material fractions. The characteristic feature is that the X-ray analysis system, is additionally equipped with a hyper-spectral analysis system in the range of infra-red radiation using a source of infra-red radiation and hyper-spectral camera analysing the image of rays reflected from the surface of the material being tested. The X-ray system has a multi-band X-ray detectors in the form of matrices arranged in a series of independent X-ray sensors covering the entire width of the conveyor belt, as well as radiation detectors have a possibility to detect photons at different radiation energy levels after passing through the tested material thus being exposed to varied X-ray attenuation effect. The hyper-spectral infra-red radiation camera has an optical system covering the entire width of the conveyor belt and has a possibility to analyse the reflectance factor of the tested material surface in multiple spectral ranges of the infra-red light. The X-ray source has the ability to generate stable X-ray photon energy over the entire width of the conveyor belt and the infra-red light source has the ability to generate stable infra-red light beam over the entire belt width. Beneficially, the system has no less than two units of the device receiving separated fractions of material. Beneficially, the devices receiving the separated fractions of material are in the form of containers. Beneficially, the devices receiving separated fractions of material are in the form of conveyor belts transporting the separated material and/or in the form of transfer channels transporting the separated material.

The method of material analysis and separation to determine their chemical composition for their further separation is characterized by introduction of the measured material between the X-ray source and radiation detectors with controlled speed of the conveyor belt and/or with velocity controlled by means of gravity or other known system generating steady movement of the material and a multi-band X-ray detector measures the quantity and energy of X-ray photons for individual independent energy bands and presents them in the form of electrical pulses with intensity proportional to photon energy. Beneficially, the multi-band X-ray detector measures the amount and energy of the X-ray photons for individual independent energy bands in an aggregate or group or individual manner. In infra-red spectrum, the intensity of photons is analysed in various light band frequencies and classified into frequency ranges.

Beneficially, the system of processing data from multi-band detectors calculates and classifies electric pulses from sensors presenting them in the form of distribution of the number of measured photons for individual X-ray energy bands. Beneficially, the system of processing data from multi-band detector and from radiation detectors presents the distribution of the number of measured photons for a given number of independent X-ray energy bands in the quantity from two to even several hundred bands. Beneficially, the source of infra-red radiation has the ability to generate a stable beam of photons over the entire width of the conveyor belt. Beneficially, the source of infra-red radiation generates a stable beam of photons in a wide frequency range, or only in narrow selected bands of this type of radiation. Beneficially, the measured surface of the material is introduced in the immediate vicinity of the infra-red source and the hyper-spectral camera with controlled speed of the conveyor belt and/or with controlled gravitational speed. Beneficially, the measured surface of the material is introduced in the immediate vicinity of the infra-red source and the hyper-spectral camera with controlled speed of another known system generating steady movement of the material. Beneficially, the source of infra-red radiation illuminates the surface of the material and the hyper-spectral infra-red camera measures the intensity of the infra-red photons reflected from the surface of the material for individual independent frequency bands of infra-red radiation and presents them in the form of electric pulses with intensity proportional to the intensity of the photons. Beneficially, the system of processing data from the hyper-spectral camera presents the intensity distribution of the measured photons for a given number of independent infra-red radiation frequency bands in a quantity from one band to even several hundred bands, simultaneously. Beneficially, the computed calculation system determining the material separation criteria, recognizes the differences in the distribution of the quantity of the measured photons for individual X-ray energy bands and, at the same time, recognizes the differences in the distribution of the quantity of the measured photons for individual infra-red radiation frequency bands, thus defining the differences between separated materials and their properties.

Beneficially, the computed calculation system determining the material separation criteria, through the given parameters of the separation criteria, completely independently selects individual X-ray energy bands and individual infra-red frequency bands, and compares the values corresponding to the quantities and intensities measured in these photon bands.

Beneficially, the computed calculation system determining the material separation criteria compares the values corresponding to the quantities and intensities measured in these photon bands by performing computed mathematical operations.

Beneficially, the computed calculation system determining the material separation criteria is based on previous laboratory measurements determining the best configurations of numbers corresponding to the content of photons in individual X-ray energy bands and the intensity of photons in individual infra-red radiation bands to distinguish the separated materials.

Beneficially, the system for rejection of material particles falling below the separation criterion threshold determines the delay and pulse duration to control the actuators of the rejection system so as to effectively reject selected material particles when they appear at the outlet of the conveyor belt regardless of their position relative to its conveyor bind width.

Beneficially the rejection system controls a plurality of pneumatic nozzles arranged in a row across the width of the belt.

Beneficially the rejection system controls a plurality of mechanical blades arranged in a row across the width of the belt.

Beneficially, the rejection system controls the actuators, which are arranged in a row across the width of the belt, below and/or above the material trajectory, and reject particles upwards and/or downwards.

The subject of the invention has been shown in the installation example on a system drawing, in which

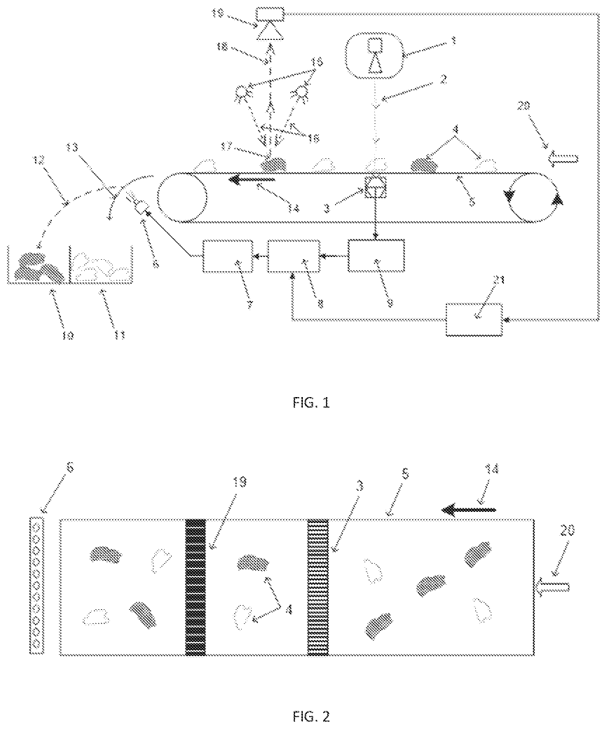

FIG. 1 is a block diagram of the process in a side view, and

FIG. 2 is the process top view.

The conveyor belt 5 holds a single layer of material 4 intended to be sorted. Above the conveyor, there is the X-ray source 1, which emits radiation 2 in the direction perpendicular to the conveyor belt 5 moving in the direction 14. Under the conveyor, there are X-ray detectors 3, which transmit the signal to the data processing system in the form of a multi-band detector 9 and then to the main computing unit 8. The X-radiation source 1 completely covers the width of conveyor belt 5 emitting the same energy relative to the width. Multi-band radiation detectors 9 consist of multiple radiation sensors, thus analysing each point across the width of the conveyor band independently in the range of independent energy bands. As material 4 moves on the conveyor belt 5 in the direction 20, an image of the entire analysed material particles is generated line by line. The main computing unit 8 analyses the signal from the system processing data received from multi-band detector 9, and, based on the set parameters of the separating device, a decision is made to reject material particles with different properties. As a result, information regarding the decision to separate such particles is transmitted to rejection system 7 and pneumatic nozzles 6 of the rejection system are activated with an appropriate time delay. In this way, particles with different properties are separated into container 10 according to trajectory 12, and non-discarded particles fall freely into container 11 according to trajectory 13. Over the entire width of the conveyor belt, regardless of the position of the particles relative to the belt, the rejection system operates nozzle system 6, which consists of multiple independent compressed air nozzles that are activated at the right time and in the appropriate zone relative to the width of the belt. Infra-red radiation source 15 has the ability to generate a stable photon beam over the entire width of conveyor belt 5.

Infra-red radiation source 15 generates a stable beam of photons in a wide frequency range, or only in narrow selected bands of such radiation. Measured surface 17 of material 4 is introduced in the immediate vicinity of infra-red source 15 and hyper-spectral camera 19 with controlled speed of conveyor belt 5 and/or with controlled gravitational speed.

Measured surface 17 of material 4 is introduced in the immediate vicinity of infra-red source 15 and hyper-spectral camera 19 with controlled speed of another known system generating steady movement of the material.

Source of infra-red radiation 15 illuminates material surface 17 and the hyper-spectral infra-red camera 19 measures the intensity of infra-red photons 16 reflected from material surface 17 for individual independent frequency bands of infra-red radiation and presents them in the form of electric pulses with intensity proportional to the intensity of the photons.

System of processing data 21 from hyper-spectral camera 19 presents the intensity distribution of the measured photons for a given number of independent infra-red radiation frequency bands in a quantity from one band to even several hundred bands, simultaneously.

Computed calculation system 8 determining material 4 separation criteria, recognizes the differences in the distribution of the quantity of the measured photons for individual X-ray energy bands and, at the same time, recognizes the differences in the distribution of the quantity of the measured photons for individual infra-red radiation frequency bands, thus defining the differences between separated materials and their properties.

Computed calculation system 8 determining the material separation criteria, through the given parameters of the separation criteria, completely independently selects individual X-ray energy bands and individual infra-red frequency bands, and compares the values corresponding to the quantities and intensities measured in these photon bands 18. Computed calculation system 8 determining material 4 separation criteria compares the values corresponding to the quantities and intensities measured in these photon bands by performing computed mathematical operations.

Computed calculation system 8 determining the material separation criteria is based on previous laboratory measurements determining the best configurations of numbers corresponding to the content of photons in individual X-ray energy bands and the intensity of photons in individual infra-red radiation bands to distinguish the separated materials.

System for rejection 7 of material 4 particles falling below the separation criterion threshold determines the delay and pulse duration to control the actuators of the rejection system so as to effectively reject selected material particles when they appear at the outlet of the conveyor belt regardless of their position relative to its conveyor belt width.

Rejection system 7 controls multiple pneumatic nozzles 6 arranged in a row across the width of the conveyor belt, controls numerous mechanical blades arranged in a row across the width of the conveyor belt and controls actuators arranged in a row across the width of the belt, under and/or above material 4 trajectory and rejecting particles upwards and/or downwards.

### LIST OF MARKINGS

1—X-ray source
2—X-ray photons
3—X-ray detectors
4—tested material
5—conveyor belt
6—pneumatic nozzles
7—rejection system
8—computed calculation system
9—multi-band radiation detector
10,11 receiving devices
12,13 material falling trajectory
14—material movement direction
15—source of infra-red radiation
16—infra-red radiation photons
17—reflected material surface
18—direction of reflected photons
19—hyper-spectral camera
20—conveyor belt direction
21—infra-red data processing system

1.-24. (canceled)

25. A material analysis and separation system, comprising:
a conveyor belt, a X-ray source, and a X-ray detector;
the X-ray source (1) is located in such a way that X rays (2) penetrate a measured material over the entire width of the conveyor belt;
the X-ray detector is a multi-band X-radiation detector (9) consisting of multiple radiation sensors (3) located along the entire width of the belt;
the X-ray detector further comprising devices that allow for data processing in a dual energy (DE Dual Energy) or a multi-energy (ME Multi Energy) X-ray analysis range detecting different X-ray attenuation effect by the measured material (4); and
wherein an X-ray analysis system in the X-ray detector includes a hyper-spectral analysis system in the range of infra-red radiation using a source of infra-red radiation (15) and a hyper-spectral camera (19) analyzing an image of rays reflected from a surface (17) of the material (4) being tested, allowing material type characteristics based on specific reflectance effect to be determined, and wherein the system includes a computer that controls the materials analysis and separation system to reject material particles falling below a separation criterion threshold and a plurality of devices receiving separated material fractions (10,11).

26. The system according to claim 25 characterized by having the hyper-spectral infra-red radiation camera (19) as an optical system covering the entire width of the conveyor belt (5).

27. The system according to claim 25 characterized by the X-ray source (1) generating a stable X-ray photon energy (2) over the entire width of the conveyor belt (5).

28. The system according to claim 25 characterized by having no less than two units of the device (10,11) receiving the separated fractions of material (4).

29. The system according to claim 25 characterized by the container form (10,11) of the device receiving the separated fractions of material.

30. The system according to claim 29 characterized by the devices receiving 10,11) separated fractions of material in the form of conveyor belts transporting the separated material or in the form of transfer channels transporting the separated material.

31. A method of material analysis and separation, to determine a material chemical composition for further separation is characterized by the steps of:
providing a system according to claim 25;
introducing the measured material (4) between the X-ray source (1) and the radiation detectors (3) with a controlled speed of the conveyor belt (5) and with velocity controlled by a means of gravity generating a steady movement of the material;
measuring, with the X-ray beam (2) and detector (9) the quantity and energy of X-ray photons (2) passing the material for individual independent energy bands and presenting the results in the form of electrical pulses with intensities proportional to photon energy.

32. The method according to claim 31 characterized by the X-ray beam (2) and detectors (9) measuring of the amount and energy of the X-ray photons for individual independent energy bands in an aggregate or an individual manner.

33. The method according to claim 31 characterized by the multi-band detector (9) data processing system's calculating and classifying of electric pulses from the sensors and presenting them as distribution of the measured photon quantity for individual X-ray energy bands.

34. The method according to claim 33 characterized by the multi-band detector (9) and radiation detector (3) data processing system, presenting of the distribution of the measured photon quantity for a given number of independent X-ray energy bands in the amount of two to several hundred bands.

35. The method according to claim 31 characterized by the source of infra-red radiation (15) having the ability to generate a stable beam of photons over the entire width of the conveyor belt (5).

36. The method according to claim 35 characterized by the source of infra-red radiation (15) generating a stable beam of photons in a wide frequency range, or only in narrow selected bands of this type of radiation.

37. The method according to claim 31 characterized by the measured surface (17) of the material (4) being introduced in the immediate vicinity of the infra-red radiation source (15) and the hyper-spectral camera (19) with controlled speed of the conveyor belt (5) and/or with control led gravitational speed.

38. The method according to claim 37 characterized by the measured surface (17) of the material (4) being introduced in the immediate vicinity of the infra-red radiation source (15) and the hyper-spectral camera (19) with controlled speed of another known system generating steady movement of the material.

39. The method according to claim 37 characterized by the source of infra-red radiation (15) illuminating the material surface (17) and the hyper-spectral infra-red camera (19) measuring the intensity of the infra-red photons (16) reflected from the material surface (17) for individual independent frequency bands of infra-red radiation and presenting them in the form of electric pulses with intensity proportional to the intensity of the photons.

40. The method according to claim 39 characterized by the system of processing data (21) from the hyper-spectral camera (19) presenting the intensity distribution of the measured photons for a given number of independent infra-red radiation frequency bands in a quantity from one band to even several hundred bands, simultaneously.

41. The method according to claim 31 characterized by the computed calculation system (8) determining the material (4) separation criteria recognizing the differences in the distribution of the quantity of the measured photons for individual X-ray energy bands and, at the same time, recognizing the differences in the distribution of the quantity of the measured photons for individual infra-red radiation frequency bands, thus defining the differences between separated materials and their properties.

42. The method according to claim 41 characterized by the computed calculation system (8), determining the material separation criteria through the given parameters of the separation criteria, completely independently selecting individual X-ray energy bands and individual infra-red frequency bands, and comparing the values corresponding to the quantities and intensities measured in these photon bands.

43. The method according to claim 42 characterized by the computed calculation system (8), determining the material (4) separation criteria, comparing the values corresponding to the quantities and intensities measured in these photon bands by performing computed mathematical operations.

44. The method according to claim 43 characterized by the computed calculation system (8), determining the material separation criteria, basing on previous laboratory measurements determining the best configurations of numbers corresponding to the content of photons in individual X-ray energy bands and the intensity of photons in individual infra-red radiation bands to distinguish the separated materials.
